(19) United States
(12) Patent Application Publication
(10) Pub. No.: US 2026/0330516 A1
(43) Pub. Date: Oct. 22, 2026

(54) Fee Calculation System and Fee Calculation Method

(71) Applicant: Hitachi Industrial Equipment Systems Co., Ltd., Chiyoda-ku, Tokyo (JP)

(72) Inventors: Yuta KAJIE, Tokyo (JP); Kenji MORITA, Tokyo (JP); Shigeyuki YORIKANE, Tokyo (JP)

(21) Appl. No.: 19/113,190

(22) PCT Filed: Dec. 27, 2022
(86) PCT No.: PCT/JP2022/048395

§ 371 Date: Mar. 19, 2025

(51) Int. Cl. G06Q 30/0283; G06Q 10/20

(52) U.S. Cl. CPC G06Q 30/0283; G06Q 10/20

(57) ABSTRACT

A fee calculation system includes a calculation device that calculates a usage fee of an air compressor. The calculation device acquires environmental information that is information relating to an installation environment of the air compressor, and calculates a replacement cycle of a component that configures the air compressor on the basis of the acquired environmental information. Further, the calculation device calculates a usage fee of the air compressor on the basis of the calculated replacement cycle, and outputs the calculated usage fee of the air compressor.

### TECHNICAL FIELD

The present invention relates to a fee calculation system and a fee calculation method.

### BACKGROUND ART

Conventionally, an air compressor that generates compressed air is known. Patent Document 1 describes a compressed air supply system in which a sensor that senses the pressure in a flow path is disposed on the flow path of an air compressor and a usage fee of compressed air is calculated on the basis of the sensed pressure.

### PRIOR ART DOCUMENT

### Patent Document

Patent Document 1: JP-2004-84540-A

### SUMMARY OF THE INVENTION

### Problem to be Solved by the Invention

In the case of conducting lease or rental of an air compressor by the compressed air supply system of the conventional technology, the replacement cycle of components is proposed on the basis of the assumption of use conditions under which the components are overused and exhausted at the highest degree. Thus, there is a problem that early replacement is recommended despite a component that can be used for a longer time depending on the use environment, and a large amount of waste is discharged.

The present invention intends to provide a fee calculation system and a fee calculation method that can suppress discharge of waste by avoiding unnecessary replacement of a component.

### Means for Solving the Problem

A fee calculation system according to one aspect of the present invention is a fee calculation system including a calculation device configured to calculate a usage fee of an air compressor. The calculation device is configured to acquire environmental information that is information relating to an installation environment of the air compressor, and calculate a replacement cycle of a component that configures the air compressor on the basis of the environmental information acquired. Further, the calculation device is configured to calculate a usage fee of the air compressor on the basis of the replacement cycle calculated, and output the calculated usage fee of the air compressor.

### Advantages of the Invention

According to the present invention, discharge of waste can be suppressed by avoiding unnecessary replacement of the component.

### BRIEF DESCRIPTION OF THE DRAWINGS

FIG. 1 is a diagram for explaining a use method for a fee calculation system according to a first embodiment of the present invention.

FIG. 2 is a block diagram schematically depicting the hardware configuration of a server.

FIG. 3 is a block diagram schematically depicting the configuration of the server.

FIG. 4 is a schematic diagram depicting the configuration of an air compressor.

FIG. 5 is a diagram schematically depicting the relationship between the amount of dust/dirt in an ambient environment and the clogging state of a suction filter.

FIG. 6 is a diagram schematically depicting the relationship between the operation state of the air compressor in one day and the amount of dust accumulated in the suction filter.

FIG. 7 is a diagram depicting a display example of the usage fee of the previous day displayed on a display section.

FIG. 8 is a flowchart of control processing executed by a control section of the air compressor.

FIG. 9 is a flowchart of control processing executed by a calculation device of the server.

FIG. 10 is a diagram for explaining a use method for a fee calculation system according to a second embodiment of the present invention.

FIG. 11 is a diagram schematically depicting the relationship between filter pressure loss and filter clogging.

### MODES FOR CARRYING OUT THE INVENTION

### First Embodiment

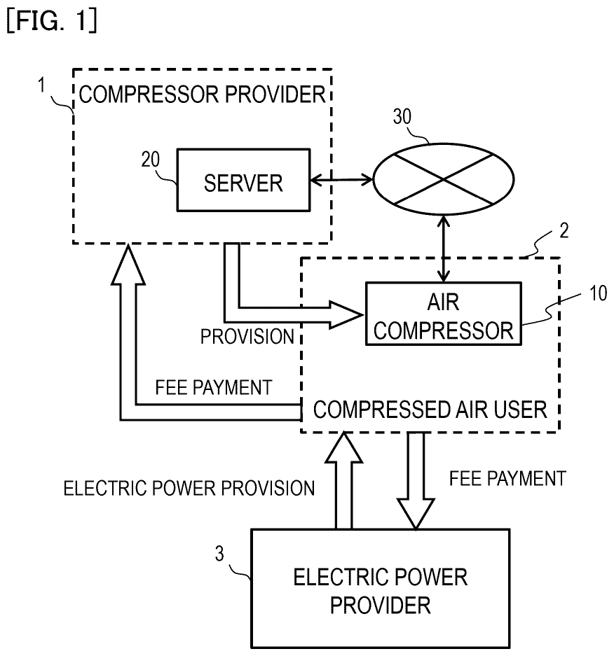

A fee calculation system according to a first embodiment of the present invention is described with reference to FIGS. 1 to 9.

FIG. 1 is a diagram for explaining a use method for the fee calculation system according to the first embodiment of the present invention. A compressor provider 1 provides an air compressor 10 to a compressed air user 2 and receives a compressor usage fee for every predetermined period (for example, every day) in exchange for provision of the air compressor 10. The compressed air user 2 obtains compressed air by operating the air compressor 10, which is provided from the compressor provider 1, by electric power provided from an electric power provider 3. The electric power provider 3 provides the electric power necessary for operation of the air compressor 10 to the compressed air user 2 and receives an electricity fee corresponding to the amount of electric power in exchange for provision of the electric power.

The compressor provider 1 owns a server 20 that functions as the fee calculation system. The air compressor 10 and the server 20 are mutually connected by a network 30. As described later, sensors that determine whether the installation environment is favorable are disposed in the air compressor 10. The air compressor 10 transmits information relating to the installation environment sensed by the sensors to the server 20 through the network 30. The server 20 calculates a discount amount with respect to the usage fee of the air compressor 10 on the basis of the information relating to the installation environment received from the air compressor 10. The compressor provider 1 charges the compressed air user 2 the usage fee resulting from subtraction of the discount amount calculated by the server 20. The server 20 transmits information relating to the usage fee to which the discount amount has been applied, to the air compressor 10 through the network 30. The air compressor 10 displays the usage fee on a display mounted on the air compressor 10.

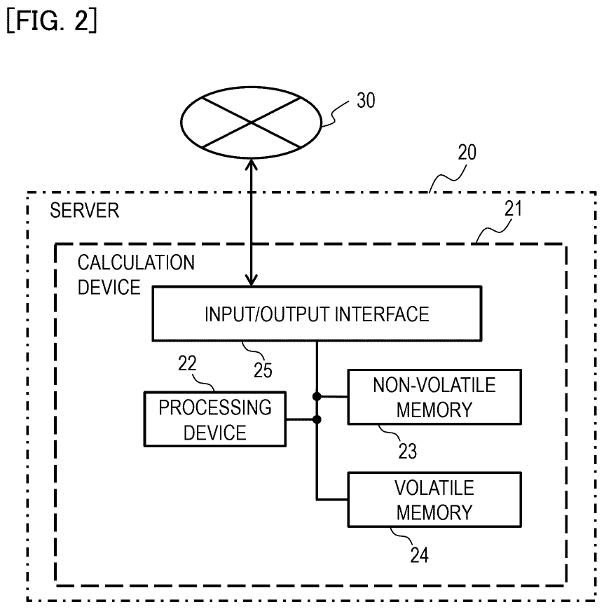

FIG. 2 is a block diagram schematically depicting the hardware configuration of the server 20. The server 20 includes a calculation device 21. The calculation device 21 is configured by a computer including a processing device 22 such as a CPU (Central Processing Unit), an MPU (Micro Processing Unit), or a DSP (Digital Signal Processor), a non-volatile memory 23 such as a ROM (Read Only Memory), a flash memory, or a hard disk drive, a volatile memory 24 referred to as what is called a RAM (Random Access Memory), an input/output interface 25, and other peripheral circuits. These pieces of hardware cooperate to operate software and implement a plurality of functions. It is to be noted that the calculation device 21 may be configured by one computer or be configured by a plurality of computers. Further, an ASIC (application specific integrated circuit), an FPGA (Field Programmable Gate Array), or the like can be used as the processing device 22.

A program that can execute various computations is stored in the non-volatile memory 23. That is, the non-volatile memory 23 is a storage medium (storage device) that can read the program that implements functions of the present embodiment. The volatile memory 24 is a storage medium (storage device) that temporarily stores a computation result obtained by the processing device 22 and a signal input from the input/output interface 25. The processing device 22 is a device that loads the program stored in the non-volatile memory 23 into the volatile memory 24 and executes computation and executes predetermined computation processing for data taken in from the input/output interface 25, the non-volatile memory 23, and the volatile memory 24 in accordance with the program.

An input section of the input/output interface 25 converts a signal input from the network 30 to data for which computation by the processing device 22 is possible. An output section of the input/output interface 25 generates a signal for output corresponding to the result of the computation in the processing device 22 and outputs the signal to the network 30.

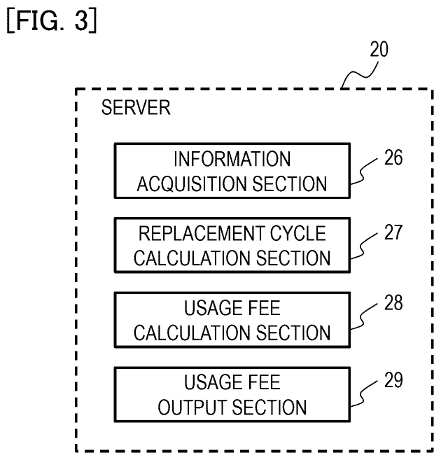

FIG. 3 is a block diagram schematically depicting the configuration of the server 20. The server 20 includes an information acquisition section 26, a replacement cycle calculation section 27, a usage fee calculation section 28, and a usage fee output section 29. The information acquisition section 26 acquires environmental information that is information relating to the installation environment of the air compressor 10, from the air compressor 10. The replacement cycle calculation section 27 calculates the replacement cycle of components that configure the air compressor 10 on the basis of the environmental information acquired by the information acquisition section 26. The usage fee calculation section 28 calculates the usage fee of the air compressor 10 on the basis of the replacement cycle calculated by the replacement cycle calculation section 27. The usage fee output section 29 outputs, to the air compressor 10, the usage fee of the air compressor 10 calculated by the usage fee calculation section 28.

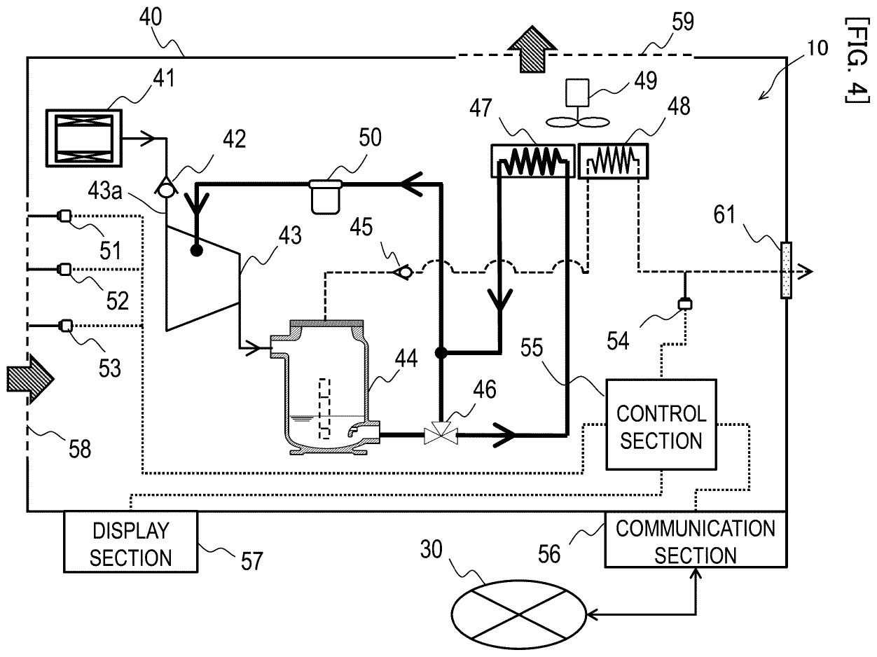

FIG. 4 is a schematic diagram depicting the configuration of the air compressor 10. The air compressor 10 is what is called a liquid-cooled air compressor. The air compressor 10 includes a suction filter 41, a suction throttle valve 42, a compressor main body 43, an oil case 44, a pressure regulating check valve 45, a temperature control valve 46, a coolant cooler 47, an after-cooler 48, a cooling fan 49, a coolant filter 50, a dust/dirt sensor 51, a temperature sensor 52, a humidity sensor 53, a discharge pressure sensor 54, a control section 55, a communication section 56, and a display section 57. In a casing 40 of the air compressor 10, an intake port 58, an air exhaust port 59, and a discharge port 61 are disposed. The control section 55 is configured by a computer including a processing device, a storage device, and the like similarly to the server 20.

The suction filter 41 is a filter for preventing dust/dirt from flowing into the compressor main body 43. The suction filter 41 is disposed on the upstream side of an intake port 43a of the compressor main body 43. The suction throttle valve 42 is a throttle valve for regulating the flow rate of air that has flown into the air compressor 10 through the suction filter 41 and flows toward the compressor main body 43. The compressor main body 43 is, for example, a compressor (compression section) that is electrically driven to compress air, and is a central part of the air compressor 10.

The compressor main body 43 cools compressed air by transferring heat generated when air is compressed to a coolant (for example, oil or the like). The compressed air and the coolant are sent from the compressor main body 43 to the oil case 44.

The oil case 44 separates the compressed air and the coolant from each other and accumulates the coolant. The coolant separated here is cooled by the coolant cooler 47. It is to be noted that the coolant is regulated by the temperature control valve 46 so as to be kept from being excessively cooled. The cooled coolant passes through the coolant filter 50 and is supplied to the compressor main body 43 again. The coolant filter 50 is a filter for removing sludge and the like contained in the coolant that cools the compressed air.

The compressed air separated from the coolant in the oil case 44 passes through the pressure regulating check valve 45 and is introduced to the after-cooler 48. The after-cooler 48 further cools the compressed air by the necessary amount of cooling. The compressed air cooled by the after-cooler 48 is discharged from the discharge port 61 disposed in the casing 40 of the air compressor 10 toward a demanding destination.

The cooling fan 49 is an air cooling fan for cooling the coolant cooler 47 and the after-cooler 48. The cooling fan 49 cools the coolant cooler 47 and the after-cooler 48 by blowing air sucked from the intake port 58 over the coolant cooler 47 and the after-cooler 48. The cooling fan 49 exhausts the air containing exhaust heat of the coolant cooler 47 and the after-cooler 48 from the air exhaust port 59 to the external of the casing 40.

The discharge pressure sensor 54 measures the pressure of the compressed air to be discharged toward the demanding destination. The discharge pressure sensor 54 is disposed near the discharge port 61. The control section 55 controls activation and stop of the compressor main body 43 and controls the load of the compressor main body 43 on the basis of the value of the pressure measured by the discharge pressure sensor 54. The dust/dirt sensor 51, the temperature sensor 52, and the humidity sensor 53 are disposed near the intake port 58 and the suction filter 41, and measure the amount of dust/dirt (dust/dirt concentration), the temperature, and the humidity, respectively, regarding the installation environment of the air compressor 10.

The suction filter 41 and the coolant filter 50 progress in deterioration when the air compressor 10 is operated. In general, these components are replaced at a replacement cycle that is set in consideration of the most severe condition assumed as the installation environment and the operation state of the air compressor 10. However, all air compressors 10 are not used under such a severe condition. Thus, the server 20 of the present embodiment considers the cycle of component replacement while determining, regarding each air compressor 10, whether the installation environment thereof is favorable and how much the operation load is.

In the present embodiment, the environmental information is calculated for every certain period. The environmental information includes values that represent the amount of dust/dirt regarding each filter and the operation time used for calculation of the amount of dust/dirt. The environmental information further includes measurement values of the dust/dirt sensor 51, the temperature sensor 52, and the humidity sensor 53 acquired for every certain period. The control section 55 transmits (outputs) the environmental information from the communication section 56 to the server 20. The server 20 receives the environmental information from the air compressor 10 and calculates the cycle of component replacement for each component on the basis of the received environmental information. The server 20 calculates a fee discounted from a flat-rate fee and the usage fee resulting from application of the discount (fee that the user is charged actually) on the basis of the calculated replacement cycle of each component.

The environmental information is described. The control section 55 calculates the load rate of the compressor main body 43. The load rate can be calculated by the following formula (1) from a value measured by the discharge pressure sensor 54 and the operation status of activation/stop. Here, Lr is the load rate of the compressor main body 43. T1 is the time of loading operation in which air is being compressed and discharged. T2 is the time of unloading operation in which compressed air is not being discharged.

$$[ Formula 1 ]$$

$${L}_{r} = \frac{{T}_{1}}{( {T}_{1} + {T}_{2} )} \qquad ( 1 )$$

The control section 55 compares the pressure measured by the discharge pressure sensor 54 with a threshold of a control pressure that is set in advance by the compressed air user 2, and determines whether the air compressor 10 is currently executing the loading operation or executing the unloading operation. For example, in the case in which the rotation speed of the compressor main body 43 is variable and the rotation speed is controlled by the control section 55, the control section 55 controls the rotation speed such that the pressure measured by the discharge pressure sensor 54 becomes constant. In this case, the control section 55 calculates the load rate on the basis of information on the controlled rotation speed.

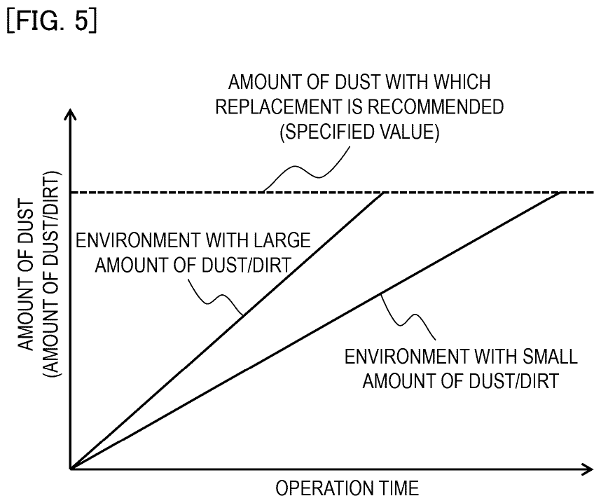

FIG. 5 is a diagram schematically depicting the relationship between the amount of dust/dirt in the ambient environment and the clogging state of the suction filter 41. A description is given below by taking the suction filter 41 as an example.

In general, the amount of dust with which replacement is recommended is set for the filter. When the amount of dust has become equal to or larger than a specified value, a trouble that the filter is clogged and it becomes impossible to take in a predetermined amount of air occurs. In the air compressor 10, the amount of dust accumulated in the filter is calculated by the following formula (2). Here, E is the amount of accumulated dust [g]. Q is the amount of air [m³/minute] taken in when the compressor main body 43 operates at a load rate of 100%. Lr is the load rate of the compressor main body 43 calculated by formula (1). F is the dust/dirt concentration [g/m³] in the installation environment measured by the dust/dirt sensor. t is the operation time [minutes].

[Formula 2]

E=Q×Lᵣ×F×t (2)

The larger the amount of dust/dirt in the installation environment is, the shorter the time until the specified amount of dust is reached is. Similarly, the larger the amount of dust/dirt in the installation environment is, the higher the decrease rate of the amount of air taken in is. Therefore, with information on the load rate calculated by the control section 55 and the amount of dust/dirt measured by the dust/dirt sensor 51, the time until the specified amount of dust is reached, namely, the replacement cycle, can be predicted.

The server 20 receives, from the air compressor 10, the cumulative value E of the amount of dust (the amount of dust/dirt) calculated by formula (2) and the operation time t used for the calculation of formula (2) as information relating to the installation environment of the air compressor 10. The server 20 calculates the time change rate (slope in FIG. 5) of the cumulative value of the amount of dust (the amount of dust/dirt) (the amount of dust captured by the suction filter 41), and predicts the operation time until the cumulative value of the amount of dust reaches the threshold in the case in which the cumulative value of the amount of dust increases at the calculated time change rate, namely, the replacement cycle.

The description has been given above regarding the suction filter 41. However, also regarding other filters, the replacement cycle can be predicted when a similar consideration is executed. It is to be noted that, although here the description has been given with focus only on dust/dirt, the deterioration of components progresses also due to the influence of the ambient temperature and humidity, and therefore it is desirable to predict the replacement cycle while taking also these kinds of information into consideration. For example, the specified amount of dust is deemed as a function of the ambient temperature and humidity as indicated by the following formula (3). Here, E* is the specified value of the amount of dust used for prediction of the replacement cycle. En is the amount of dust with which replacement is recommended when the ambient environment is in a standard state. T is the temperature of the installation environment measured by the temperature sensor 52. H is the humidity of the installation environment measured by the humidity sensor 53. 1 and m are predetermined exponents. The server 20 calculates the specified value E* of the amount of dust by using the following formula (3), and predicts the replacement cycle by using it and the amount of dust/dirt E calculated by formula (2).

[Formula 3]

E*=Eₙ×T^{l}×H^{m} (3)

The server 20 predicts the replacement cycle regarding each component of the air compressor 10 on the basis of the environmental information received from the air compressor 10. The server 20 calculates the usage fee by the following formula (4) from the predicted replacement cycle. Here, Y is a usage fee [yen/day] per one day. A is a flat-rate fee [yen/day] per one day. Bi is maintenance cost [yen] when each replacement component is replaced at a recommended replacement cycle. Ci is the number of days until replacement [days] recommended for each replacement component. Di is the number of days until replacement [days] predicted by computation by the server 20 regarding each replacement component. N is the number of replacement components in the air compressor 10. The usage fee Y calculated here is an amount resulting from a discount by the unnecessary maintenance cost.

$$[ Formula 4 ]$$

$$Y = A - {\sum }_{i = 1}^{N} ( \frac{{B}_{i}}{{C}_{i}} - \frac{{B}_{i}}{{D}_{i}} ) \qquad ( 4 )$$

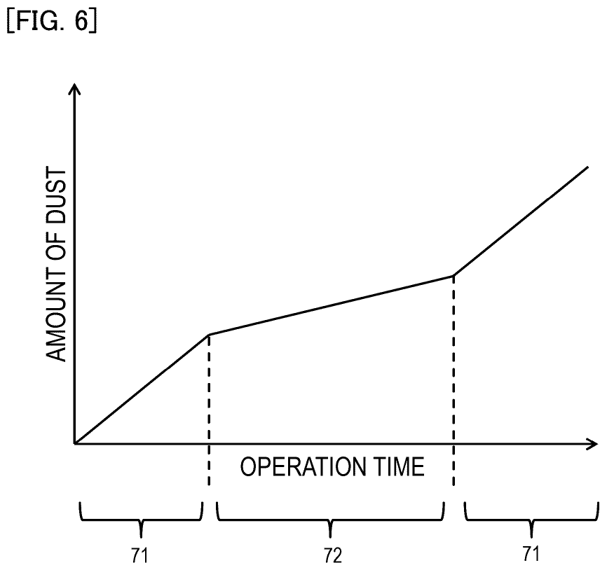

FIG. 6 is a diagram schematically depicting the relationship between the operation state of the air compressor 10 in one day and the amount of dust accumulated in the suction filter 41. A time zone 71 is a time zone in which the air compressor 10 frequently operates, and the increase rate of the amount of dust is relatively high. In this time zone 71, wasting of the suction filter 41 is intense. Thus, the usage fee is not discounted, or the discount amount is a relatively small amount. On the other hand, a time zone 72 is a time zone in which the air compressor 10 less frequently operates, and the increase rate of the amount of dust is relatively low. In this time zone 72, wasting of the suction filter 41 is relatively small, and thus the discount from the usage fee is relatively large.

For simplification of the description, in FIG. 6, the amount of dust is simply depicted by only the combination of the two slopes of the time zone 71 with frequent operation and the time zone 72 with less frequent operation. Actually, the slope of the amount of dust always varies. Thus, the accuracy becomes higher with a method in which information measured for a certain period is accumulated and the replacement cycle is predicted from a value obtained by averaging.

For example, at the end of operation on one day, the control section 55 averages data accumulated in the day by the following formula (5). Here, x̅ is the average of data accumulated in one day. xi is a value acquired at a certain timing. Nc is the number of pieces of data acquired in one day.

$$[ Formula 5 ]$$

$$\overline{x} = \frac{{\sum }_{i = 1}^{{N}_{c}} {x}_{i}}{{N}_{c}} \qquad ( 5 )$$

The control section 55 transmits (outputs) the value obtained by the averaging from the communication section 56 to the server 20. The server 20 predicts the replacement cycle of the component by formula (2) and formula (3) on the basis of the received value. The server 20 calculates the usage fee by formula (4) with use of the predicted replacement cycle. The server 20 transmits (outputs) the usage fee calculated on the previous day to the air compressor 10, at the start of operation on the next day. The control section 55 of the air compressor 10 displays the received usage fee on the display section 57 as the usage fee of the previous day to present the usage fee to the compressed air user 2.

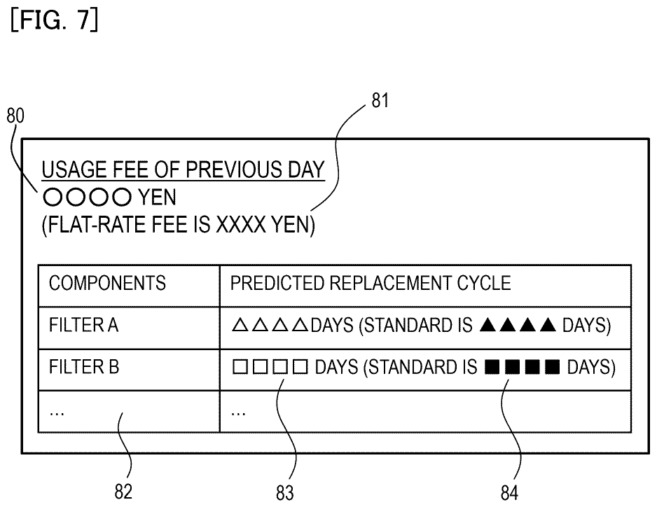

FIG. 7 is a diagram depicting a display example of the usage fee of the previous day displayed on the display section 57. In the example depicted in FIG. 7, the display section 57 displays a usage fee 80 of the previous day, a flat-rate fee 81 when no discount is applied, components 82 as replacement targets, a replacement cycle 83 of each component predicted from the installation environment and the operation status in the current situation, and a standard replacement cycle 84 of each component.

By displaying the flat-rate fee 81 when no discount is applied together with the usage fee 80 after a discount in this manner, whether the installation environment is favorable can be informed to the compressed air user 2. It is to be noted that, when the usage fee is received as a monthly fee, it is also possible to calculate an average per month from data accumulated in the server 20 in days and present the average as the usage fee of the last month.

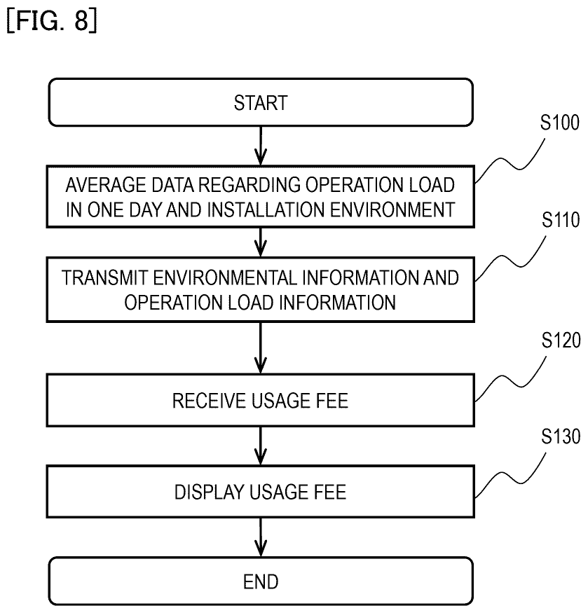

FIG. 8 is a flowchart of control processing executed by the control section 55 of the air compressor 10. In a step S100, the control section 55 calculates a value obtained by averaging data relating to the operation load in one day by using formula (5), and calculates a value obtained by averaging data relating to the installation environment by using formula (5). In a step S110, the control section 55 transmits (outputs) the values calculated in the step S100, namely, the environmental information and the operation load information, to the server 20. In a step S120, the control section 55 receives, from the server 20, the information necessary for displaying the screen depicted in FIG. 7, namely, the usage fee 80 of the previous day, the flat-rate fee 81 when no discount is applied, the components 82 as replacement targets, the replacement cycle 83 of each component predicted from the installation environment and the operation status in the current situation, and the standard replacement cycle 84 of each component. In a step S130, the control section 55 displays the information received in the step S120 on the display section 57 as in FIG. 7 to present the information to the compressed air user 2.

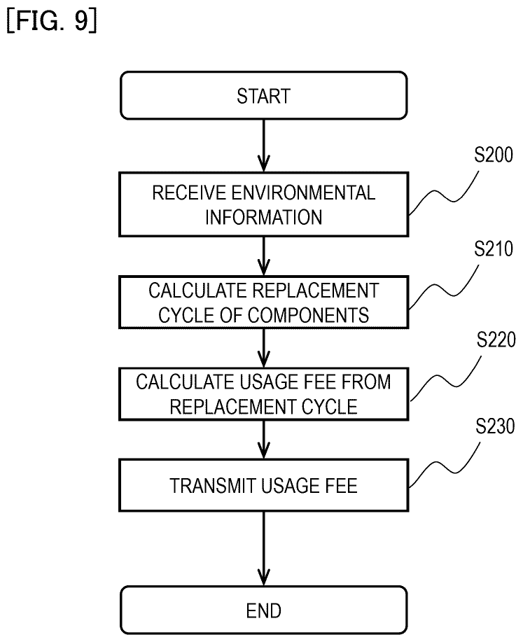

FIG. 9 is a flowchart of control processing executed by the calculation device 21 of the server 20. In a step S200, the information acquisition section 26 receives the environmental information from the air compressor 10. In a step S210, the replacement cycle calculation section 27 calculates the replacement cycle for each component on the basis of the information received in the step S200. In a step S220, the usage fee calculation section 28 calculates the usage fee after a discount on the basis of the replacement cycle calculated in the step S210 and formula (4). In a step S230, the usage fee output section 29 transmits (outputs), to the air compressor 10, the flat-rate fee before the discount, the usage fee after the discount calculated in the step S220, the replacement cycle of each component calculated in the step S210, and the standard replacement cycle of each component.

The above-described embodiment provides the following operation and effect.

(1) The calculation device 21 of the server 20 (fee calculation system) acquires the environmental information that is information relating to the installation environment of the air compressor 10, and calculates the replacement cycle of a component that configures the air compressor 10, on the basis of the acquired environmental information. Further, the calculation device 21 calculates the usage fee of the air compressor 10 on the basis of the calculated replacement cycle, and outputs the calculated usage fee of the air compressor 10. Thus, unnecessary replacement of the component of the air compressor 10 can be avoided, and excessive discharge of waste can be suppressed. Further, when the use environment is favorable and extension of the replacement cycle of components can be expected, the maintenance cost is subtracted corresponding to the extension. Thus, a lease or rental service of the air compressor 10 can be provided at a fee reasonable for the customer. Moreover, because the usage fee is lowered when the installation environment is favorable, the compressed air users 2 that attempt to make the installation environment favorable increase in the number and extension of the lifetime can be expected regarding more numbers of components than those in the current situation.

(2) The calculation device 21 acquires information that represents the temperature, the humidity, and the amount of dust/dirt regarding the installation environment, as the environmental information. Due to this, the replacement cycle of the component such as the suction filter 41 can be properly calculated.

(3) The calculation device 21 acquires, as the environmental information, values obtained by averaging the temperature, the humidity, and the amount of dust/dirt regarding the installation environment measured for every predetermined time. Because these values always vary, the prediction accuracy of the replacement cycle improves by predicting the replacement cycle from the values obtained by the averaging in this manner.

(4) The calculation device 21 calculates the replacement cycle of the suction filter (component) 41 disposed on the upstream side of the intake port 43a of the compressor main body 43 of the air compressor 10, and acquires information that represents the amount of dust/dirt captured by the suction filter 41, as the environmental information. Due to this, the replacement cycle of the suction filter 41 can be properly calculated.

(5) The calculation device 21 acquires the environmental information from the air compressor 10, and outputs the calculated usage fee of the air compressor 10 to the air compressor 10 to cause the display section 57 (display device) of the air compressor 10 to display the usage fee. This allows the compressed air user 2 to always check the latest usage fee. In addition, the flat-rate fee before a discount is displayed with the usage fee. This allows the compressed air user 2 to determine whether the installation environment of the air compressor 10 is proper or not.

### Second Embodiment

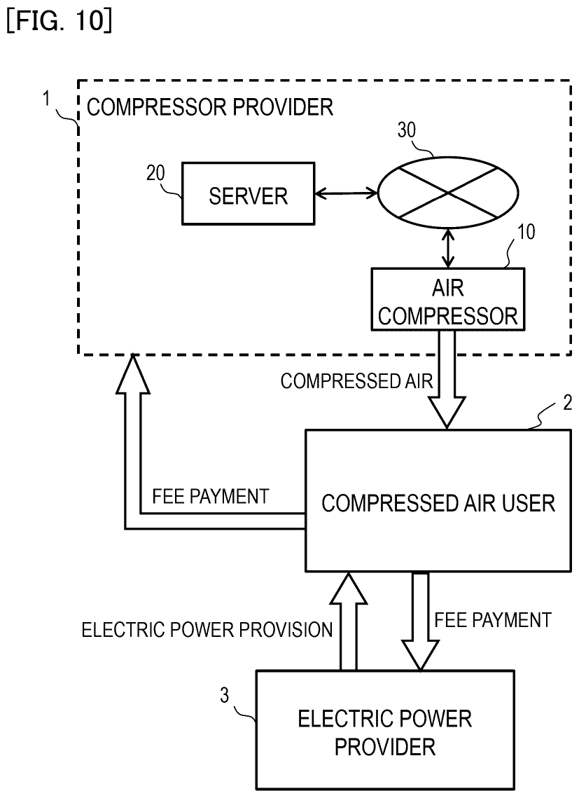

A fee calculation system according to a second embodiment of the present invention is described with reference to FIG. 10. It is to be noted that a configuration that is the same as or equivalent to a configuration described in the first embodiment is given the same reference numeral and differences are mainly described.

FIG. 10 is a diagram for explaining a use method for the fee calculation system according to the second embodiment of the present invention. In the present embodiment, the compressor provider 1 provides not the air compressor 10 but compressed air to the compressed air user 2. The compressor provider 1 receives a usage fee corresponding to the amount of compressed air used, in exchange for provision of the compressed air.

In the case of the present embodiment, the usage fee of the air compressor 10 is linked to the amount of air used. Thus, it is also possible to compute a discount amount in the air compressor 10 while predicting the replacement cycle in real time from information on the installation environment of the air compressor 10, and subtract the maintenance cost from the usage fee of the compressed air. However, payment of the usage fee is frequently conducted after use for a certain period like monthly payment or the like. Thus, it is more preferable to determine the degree of wasting in a month from information on the operation state and the installation environment accumulated for a certain period like that described in the first embodiment and give a discount from the usage fee.

The following modifications also fall within the scope of the present invention. It is also possible to combine a configuration depicted in the modification with a configuration described in the above-described embodiment, combine configurations described in the above-described different embodiments with each other, or combine configurations described in the following different modifications with each other.

### <Modification 1>

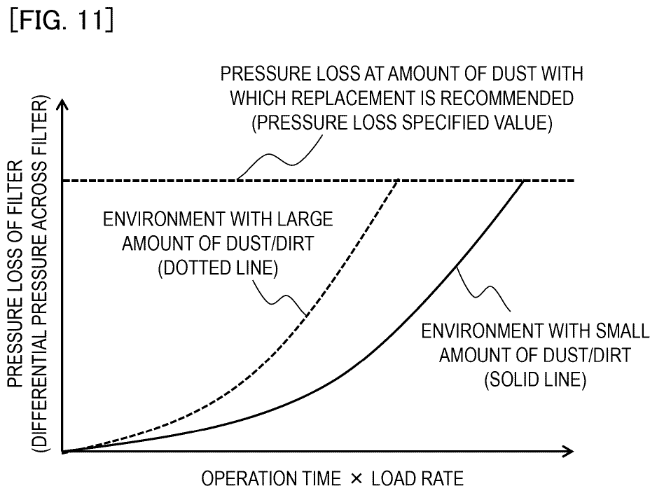

The replacement cycle of a filter may be determined without directly measuring the amount of dust/dirt by the dust/dirt sensor 51. A description is given below with reference to FIG. 11.

FIG. 11 is a diagram schematically depicting the relationship between filter pressure loss and filter clogging. In general, the higher the degree of filter clogging becomes, the higher the filter pressure loss becomes, even with the same amount of air taken in. Therefore, for example, it is also possible to determine the replacement cycle by measuring the filter pressure loss by using pressure sensors disposed across a filter.

### <Modification 2>

The dust/dirt sensor 51, the temperature sensor 52, and the humidity sensor 53 may be disposed at places different from those in the above-described embodiments. For example, these sensors may be disposed around the air compressor 10, or these sensors may be disposed near the intake port 58 and outside the casing 40. Further, when the sensors are disposed around the air compressor 10, measurement results by the sensors may be transmitted to the server 20 through the network 30.

### <Modification 3>

The components as replacement targets are not limited to the suction filter 41 and the coolant filter 50 described in the above-described embodiment. For example, with a bearing of the compressor main body 43, the coolant (oil), and the like deemed as components as replacement targets, the replacement cycle may be calculated and the maintenance cost thereof may be discounted from the usage fee. It is to be noted that, in the case of the bearing of the compressor main body 43, the temperature measured by the temperature sensor 52 is appropriate as the environmental information necessary for calculating the replacement cycle. This is because the degree of deterioration of the bearing depends on the environmental temperature. Moreover, in the case of the coolant, the humidity measured by the humidity sensor 53 is appropriate as the environmental information necessary for calculating the replacement cycle. This is because the degree of deterioration (volatilization) of the coolant depends on the environmental humidity. That is, the calculation device 21 acquires information that represents at least one of the temperature, the humidity, and the amount of dust/dirt regarding the installation environment as the environmental information, and calculates the replacement cycle of the component corresponding to the acquired environmental information on the basis of the acquired environmental information. It is to be noted that the present invention can be applied to any component besides these components by employing information, which affects the replacement cycle (degree of deterioration) of the component, as the environmental information for each of components as replacement targets.

### <Modification 4>

The display of the usage fee and the like depicted in FIG. 7 may be executed at a place other than the display section 57 disposed in the air compressor 10. For example, it is also possible to display them on a computer, a tablet terminal, or the like owned by the compressed air user 2.

### <Modification 5>

In the above-described respective embodiments, the server 20 is used as the fee calculation system. However, the air compressor 10 may be used as the fee calculation system instead of the server 20. That is, the various kinds of processing executed by the calculation device 21 of the server 20 are caused to be executed by, instead, the control section 55 of the air compressor 10. Through this, the air compressor 10 itself may be allowed to function as the fee calculation system.

Further, it is also possible to cause the control section 55 of the air compressor 10 to execute part of the processing explained as the processing executed by the calculation device 21 of the server 20 in the above-described respective embodiments. Conversely, it is also possible to cause the calculation device 21 of the server 20 to execute part of the processing explained as the processing executed by the control section 55 of the air compressor 10. Moreover, a configuration is also possible in which the server 20 is divided into a plurality of devices to cause the plurality of devices to execute, in a sharing manner, the processing explained as the processing executed by the calculation device 21 of the server 20 in the above-described respective embodiments.

Although the embodiments of the present invention have been described above, the above-described embodiments merely depict part of application examples of the present invention and do not intend to limit the technical scope of the present invention to specific configurations of the above-described embodiments.

### DESCRIPTION OF REFERENCE CHARACTERS

10: Air compressor
14: Volatile memory
20: Server
21: Calculation device
22: Processing device
23: Non-volatile memory
24: Volatile memory
25: Input/output interface
26: Information acquisition section
27: Replacement cycle calculation section
28: Usage fee calculation section
29: Usage fee output section
30: Network
40: Casing
41: Filter
42: Suction throttle valve
43: Compressor main body
43a: Intake port
44: Oil case
45: Pressure regulating check valve
46: Temperature control valve
47: Coolant cooler
48: After-cooler
49: Cooling fan
50: Coolant filter
51: Dust/dirt sensor
52: Temperature sensor
53: Humidity sensor
54: Pressure sensor
55: Control section
56: Communication section
57: Display section
58: Intake port
59: Air exhaust port
61: Discharge port

1. A fee calculation system comprising:
a calculation device configured to calculate a usage fee of an air compressor, wherein
the calculation device is configured to
acquire environmental information that is information relating to an installation environment of the air compressor,
calculate a replacement cycle of a component that configures the air compressor on a basis of the environmental information acquired,
calculate a usage fee of the air compressor on a basis of the replacement cycle calculated, and
output the calculated usage fee of the air compressor.

2. The fee calculation system according to claim 1, wherein
the calculation device acquires information that represents at least one of temperature, humidity, and an amount of dust/dirt regarding the installation environment, as the environmental information.

3. The fee calculation system according to claim 2, wherein
the calculation device acquires, as the environmental information, a value obtained by averaging at least one of the temperature, the humidity, and the amount of dust/dirt regarding the installation environment, the temperature, the humidity, and the amount of dust/dirt being measured for every predetermined time.

4. The fee calculation system according to claim 1, wherein
the calculation device is configured to calculate the replacement cycle of a filter as the component disposed on an upstream side of an intake port of a compressor main body of the air compressor, and acquires, as the environmental information, information that represents an amount of dust/dirt captured by the filter.

5. The fee calculation system according to claim 1, wherein
the calculation device acquires the environmental information from the air compressor and outputs the calculated usage fee of the air compressor to the air compressor to thereby cause a display device of the air compressor to display the usage fee.

6. A fee calculation method comprising:
acquiring environmental information that is information relating to an installation environment of an air compressor;
calculating a replacement cycle of a component that configures the air compressor, on a basis of the environmental information acquired;
calculating a usage fee of the air compressor on a basis of the replacement cycle calculated; and
outputting the calculated usage fee of the air compressor.
